(19) United States
(12) Patent Application Publication
(10) Pub. No.: US 2007/0223409 A1
(43) Pub. Date: Sep. 27, 2007

(54) System, Arrangement and Method Relating to Packet Switched Communication

(76) Inventor: Christian Herrero, Lund (SE)

Correspondence Address: ERICSSON INC., 6300 LEGACY DRIVE, M/S EVR 1-C-11, PLANO, TX, 75024, US

(21) Appl. No.: 10/597,645

(22) PCT Filed: Feb. 6, 2004
(86) PCT No.: PCT/EP04/01112

§ 371 Date: Mar. 9, 2007

(51) Int. Cl. H04B 7/00

(52) U.S. Cl. 370/310

(57) ABSTRACT

A communication system and method for prolonging a packet-switched connection between a core network node and a mobile station. When the mobile station sends a mobility management request to the core network node, the core network node decides whether or not to prolong the packet-switched connection. The core network node then informs the mobile station of the decision by including a new information element in the acceptance message. The mobile station then controls its actions based on whether or not the packet-switched connection is being prolonged.

### FIELD OF THE INVENTION

The present invention relates to a communications system supporting communication of packet data, which comprises a network with a number of packet data nodes handling connections with mobile stations, and which is supports a functionality of prolonging packet switched signalling connections between a mobile station and a network node. The invention also relates to a method in such a system and to packet data nodes through which the inventive concept can be implemented.

### STATE OF THE ART

In a communication system different protocols are provided, first in order to provide for communication between a mobile station and a network, and second for controlling the communication between a mobile station and the network. One example of such a system is a UMTS (Universal Mobile Telecommunication System). A mobile station, e.g. a mobile radio terminal, a mobile telephone, a pager, a communicator, a smart phone, an electronic organizer etc. communicates with a Core Network (CN) over a radio access network, in the case of UMTS it is UTRAN (UMTS Terrestrial Radio Access Network). A UTRAN comprises a number of base stations which are controlled by a Radio Network Controller, RNC.

In order to keep control of in which of a number of Routing Areas (RA) of the system a mobile station (MS) currently is located, mobile stations are provided with an identity of which the system has knowledge. A mobility management protocol is responsible for updating the routing area as the mobile station moves within the network, from one routing area to another.

A core network may comprise two service domains, the Circuit Switched (CS) domain and the Packet Switched (PS) domain. The present invention deals with the PS domain. The mobile station is particularly identified through IMSI (International Mobile Subscriber Identity) and a Packet Temporary Mobile Subscriber Identity, P-TMSI, which is assigned to the mobile station by the network. The PS domain of the core network particularly comprises three network nodes, namely the SGSN (Serving GPRS Support Node), the GGSN (Gateway GPRS Support Node) and a HLR (Home Location Register). Alternatively the functionality of an SGSN and a GGSN is combined in a node providing for both functionalities, CGSN.

In the PS domain, an attach procedure is performed when the mobile station connects to the network, and Routing Area (RA) updates are performed as the mobile station moves between routing areas and in many other cases as referred to in TS 24.008, i.e. routing area updates occur frequently.

The GPRS Mobility and Management protocol (GMM) is responsible for mobility management in the PS domain. The GMM protocol facilitates the mobility management communication which is logically provided between the core network and the mobile station and it is not interpreted by the UTRAN. Mobility management procedures among others relate to location management for keeping track of the current routing area of the mobile station, authentication, temporary identity management and equipment checks etc. The GMM protocol obtains and manages signalling connections for the layers above them in the protocol stack. In the PS domain, a virtual point-to-point PS signalling connection between a GMM unit in the mobile station and a GMM unit in the CN may be provided. These signalling connections are used by the MS GMM unit to perform for example routing area updates towards the CN, and to provide upper layer protocols with secure connection channels. Upper layers requesting such channels may comprise the CC (Core Control) protocol for controlling voice calls, SM (Session Management), a protocol for controlling data sessions, and for control of additional messaging services such as SMS, MMS etc. (Short Message Service, Multimedia Messaging Service). The upper layers request channels by transmitting a connection establishment to the GMM unit, which will get the channel by initiating an establishment of a signalling connection. The signalling connection is set up by lower layers, such as the Radio Resource layer (RR) or the Radio Resource Control (RRC) layer.

When GMM initiates a procedure in WCDMA (Wideband Code Division Multiple Access) mode, a PS signalling connection is initiated by transmission of a connection establishment request followed by a message for requesting a particular GMM procedure. If the GMM wishes to maintain an established connection after the GMM procedure is finished, it may indicate a Follow-On Request (FOR) in a first message for requesting a particular GMM procedure which is transmitted to the core network, particularly to SGSN. A maintained or prolonged connection may for example be desired if the GMM unit has received a connection establishment request from the upper layers, or if it has further or additional procedures that should be performed. Prolonging or maintaining connections instead of establishing a new connection decreases service response time, reduces power consumption, saves radio resources, enhances quality of services (QoS) to the upper layers and reduces signalling. 3GPP specification TS 24.008 allows the mobile station in UMTS to request for prolongation of the PS signalling connection between the mobile station and the network, i.e. the SGSN or CGSN for following or subsequent mobile station requests. This is accordingly done by setting a Follow-On Request (FOR) indicator on in the mobility management procedures Attach request or Routing Area Update request messages. These procedures are described in 3GPP TS 24.008 4.7.3 and 4.7.5, and this document herewith is incorporated herein by reference. However, in TS 24.008 it is stated that even though the terminal sets the FOR indicator on in the concerned request message (i.e. the terminal requests prolongation of the PS signalling connection), the network “should” prolong the PS signalling connection. At the same time, the SGSN “may” prolong the PS signalling connection even if the terminal has not set the FOR indicator on, i.e. the mobile has not requested a prolongation of the PS signalling connection. Further, TS 24.008 mandates the terminal to always send pending requests coming from upper layers if the terminal has set the FOR indicator on, but as referred to above, the network sometimes does actually not prolong the PS signalling connection even though requested to do so by the mobile station.

Further, in TS 24.008, it is stated that there is no acknowledgement from the network to the mobile station to indicate whether the PS signalling connection has been prolonged or not. This may lead to several disadvantageous scenarios in which errors are produced. One such scenario is when the mobile station requests for prolongation of the PS signalling connection but the network, e.g. SGSN, does not do so. Since the mobile station is not aware of this fact, since it is not indicated to it, the mobile station sends the subsequent request or requests on, as “mandated” to do, which obviously will fail. After that, the terminal is forced to request, again, the establishment of a new PS signalling connection to try once more to send the pending request(s).

Another scenario is when the mobile station does not request a prolongation of the PS signalling connection, but the SGSN (CGSN) does prolong it for some reason. The mobile station will not be aware of the signalling connection having been prolonged, which means that the mobile station, if there are pending requests, will request a PS signalling connection in order to send one or more following requests, but this would actually not have been needed, since the PS signalling connection had been prolonged and it is still up and running. This obviously leads to a disadvantageous amount of waste of radio resources, mobile station battery life and of signalling, which is sent for no use, over the air.

### SUMMARY OF THE INVENTION

What is needed is therefore a system as initially referred to, through which unnecessary or useless signalling can be reduced. Still further a system is needed through which fault situations can be avoided such as for example such in which for example a mobile station sends requests, and when subsequent requests will fail since the signalling connection has been taken down. Still further a system is needed through which it can be avoided that a mobile station erroneously will request PS signalling connections for sending subsequent requests unnecessarily when a PS signalling connection already is up and running.

Further yet a system is needed through which battery power for the mobile stations can be saved and not unnecessarily be wasted. Still further a system is needed through which a mobile station to a higher extent will be aware of what actions are taken by the core network, particularly SGSNs/CGSNs. Still further a system is needed through which the capability of a mobile station to control which actions are relevant to take, is increased. A system is also needed through which connection control is improved between a mobile station and a network node.

A packet data node through which one or more of the above mentioned objects can be achieved is also needed.

Still further a mobile station is needed, through which one or more of the objects referred to above can be achieved.

Still further a method is needed which, in a communication system supporting communication of packet data, allows for achieving one or more of the above mentioned objects.

Therefore a communications system as initially referred to is provided in which at least some of said packet data nodes comprise (control) means for providing information to a mobile station, having sent a request on an established signalling connection, to the packet data node, as to whether a packet switched signalling connection is, or is to be, prolonged or not. Preferably said (control) means in said packet data node uses a response message for responding to said request from the mobile station to include an indication as information as to whether a PS signalling connection is prolonged or not. Still further, most preferably the response message is an existing response message particularly defined for the specific request from the mobile station. Even more particularly the response message comprises an acceptance concerning the request received from the mobile station.

The request from the mobile station particularly comprises a request for connection to the network. Even more particularly the request comprises an attach request. Alternatively the request comprises a request for updating of the registration of the actual routing area of the mobile station. More generally the request comprises a mobility management request. In one implementation the request, e.g. the mobility management request, in addition, includes a request for prolongation of the established signalling connection with the packet data node. Alternatively the request from the mobile station only consists of the request itself, i.e. it does not comprise any request for prolongation of the signalling connection with the packet data node. Then a decision to prolong an established signalling connection is exclusively taken by the packet data node and not in dependence of whether there has been a request therefore or not. In a particular implementation the communication system comprises UMTS, the packet data node comprising a serving GPRS node (SGSN), or a CGSN, which is a combined SGSN-GGSN.

The prolongation request as included in, for example, a mobility management request, particularly comprises a Follow-On Request (FOR) as defined in TS 24.008.

The response message from the packet data node particularly comprises an acceptance relating to the, from the mobile station, received mobility management request, i.e. in the case of an attach request from the mobile station, it comprises an attach accept, or for a routing area update request, it comprises a routing area update accept message. Advantageously an existing, non-used part of an information element (IE) of the concerned acceptance message is used to provide the information as to whether the signalling connection is prolonged or not. In a particular embodiment the non-used part of the information element comprises one bit, which can be set to 0 or 1, wherein 0 indicates that the signalling connection is not prolonged, whereas 1 indicates that the signalling connection is prolonged. Of course it may comprise more than one bit, but advantageously a part of an information element is used which not already has been defined to be used for some other purposes. Other alternatives are however also possible. For example an indication might be provided only if a connection is prolonged, or vice versa, if it is not prolonged the mobile station knowing what it means when no information indication is provided.

Particularly a mobile station which receives an upper layer request only sends such a request on to the packet data node when no specific mobility management procedure is running, i.e. it either delays the request if such a procedure is running or alternatively it rejects the request. If the delay alternative is used, the mobile station includes the request for a prolonged signalling connection when the specific GMM procedure has been terminated.

The invention therefore also provides a packet data node to be used in a communications system supporting packet switched communication, which handles connections with mobile stations and supports a functionality of prolonging packet switched signalling connections with the mobile stations. The packet data node according to the invention comprises means for providing information to a mobile station which has sent a request to the packet data node over an established signalling connection, as to whether the packet data node is prolonging the established signalling connection or not. Particularly said means are means particularly dedicated therefore, or comprise specific control means. Alternatively said means comprise existing control means used also for other purposes. The means particularly uses a response message for responding to said request from the mobile station, which response message includes an indication as to whether the established PS signalling connection is prolonged or not. The response message particularly comprises an existing response message which is particularly defined for the specific request, which may be a mobility management request, from the mobile station. Even more particularly the response message comprises an acceptance message concerning the request received from the mobile station. The request from the mobile station may comprise a request for connection to the network, e.g. an attach request, but it may also comprise a request for updating of the registration of the actual or current routing area of the mobile station. The received request may further include a request for prolongation of the signalling connection established with the packet data node which is considered by the packet data node upon determining whether the signalling connection is to be prolonged or not. Particularly, in the packet data node or in said (control) means in the packet data node, a decision is made as to whether the established signalling connection will be prolonged independently of whether a prolongation request has been included in the request (from the MS) for a particular mobility management procedure or not. The packet data node may prolong the signalling connection also when no request therefore has been received. Particularly the packet data node comprises an SGSN. Alternatively it may comprises a CGSN. The prolongation request particularly comprises a Follow-On Request.

Particularly the response message issued by the packet data node comprises an attach accept message or a routing area update accept message and even more particularly an existing unused part of an information element of the concerned request message accept message is used to provide the information as to whether the signalling connection is prolonged or not. More generally the response message comprises an acceptance message relating to the concerned, received, mobility management request.

The invention particularly also provides for a mobile station used in a communication system supporting communication of packet data. Particularly the mobile station comprises (MS) control means for establishing or determining whether it should request prolongation of the signalling connection established or to be established with the packet data node in the core network of the packet data communication network, and for requesting prolongation, if appropriate, from the packet data node, and for establishing, based on a response message from the packet data node, whether prolongation has been performed or not, irrespectively of whether the mobile station sent a request therefore or not.

Particularly the mobile station control means includes a request for prolongation of an established signalling connection in a request for a mobility management procedure to the packet data node. The request for a mobility management procedure may comprise a request for being attached to the network, or for updating the routing area of the mobile station, e.g. an Attach request or a Routing Area Update request and, particularly, upon reception of the response message, the MS control means are able to determine whether the established signalling connection has been prolonged or not.

Even more particularly the MS control means delays or rejects upper layer requests to the packet data node if a specific mobility management procedure (GMM) is running, and when such is terminated, includes a request for prolongation in a request towards the packet data node. Particularly the MS control means controls actions concerning communication with the packet data node depending on the information in the received information messages.

The invention also suggests a method in a communication system supporting communication of packet data, relating to packet switched communication between a mobile station and a packet data node, comprising the step of establishing a signalling connection between the mobile station and the packet data node, and which comprises the further steps of; transmitting, from the mobile station, a request message to the packet data node; determining in the packet data node whether the signalling connection should be prolonged; informing the mobile station in a response message whether the signalling connection is prolonged or not; controlling actions in the mobile station in dependence on whether the signalling connection is prolonged or not.

Even more particularly the method comprises the further step of; sending a request from the mobile station to the packet data node for prolongation of the established signalling connection, whereby said request for prolongation is included in a mobility management request, e.g. an attach request or a routing area update request. Still further the method advantageously comprises the step of, on the packet data node side; including the information message in an existing, defined acceptance message relating to the received request using a spare part of an information element of said acceptance message, the acceptance message e.g. being an attach accept or a routing area update accept. More particularly the method comprises the steps of, on the mobile station side; establishing, after sending a request message, whether there is any pending upper layer request, if yes, rejecting or delaying the request until a mobility management procedure is finished; receiving the information as to whether the signalling connection is prolonged or not in the acceptance message from the packet data node; if the signalling connection is prolonged, sending the pending upper layer request, unless it was rejected; if the signalling connection is not prolonged, releasing the signalling connection. Particularly the system in which the method is used comprises a UMTS system, the packet data node being an SGSN or a CGSN.

### BRIEF DESCRIPTION OF THE DRAWINGS

The invention will in the following be more thoroughly described, in a non-limiting manner, and with reference to the accompanying drawings, in which:

FIG. 1 schematically illustrates a communication system with a mobile station MS,

FIG. 2 is a very schematical block diagram of a mobile station to which the inventive concept can be implemented,

FIG. 3 is a schematical block diagram of a packet data node in which the inventive concept can be implemented,

FIG. 4A is a signalling diagram describing one example of a procedure according to the inventive concept in which the established signalling connection is prolonged,

FIG. 4B is a signalling diagram similar to that of FIG. 4A but wherein the established signalling connection is not prolonged by the CN node,

FIG. 5 is a schematic flow diagram describing the inventive concept,

FIG. 6 is a flow diagram describing the procedure on the mobile station side, and

FIG. 7 is a flow diagram describing the procedure on the network side, i.e. in the packet data core node.

### DETAILED DESCRIPTION OF THE INVENTION

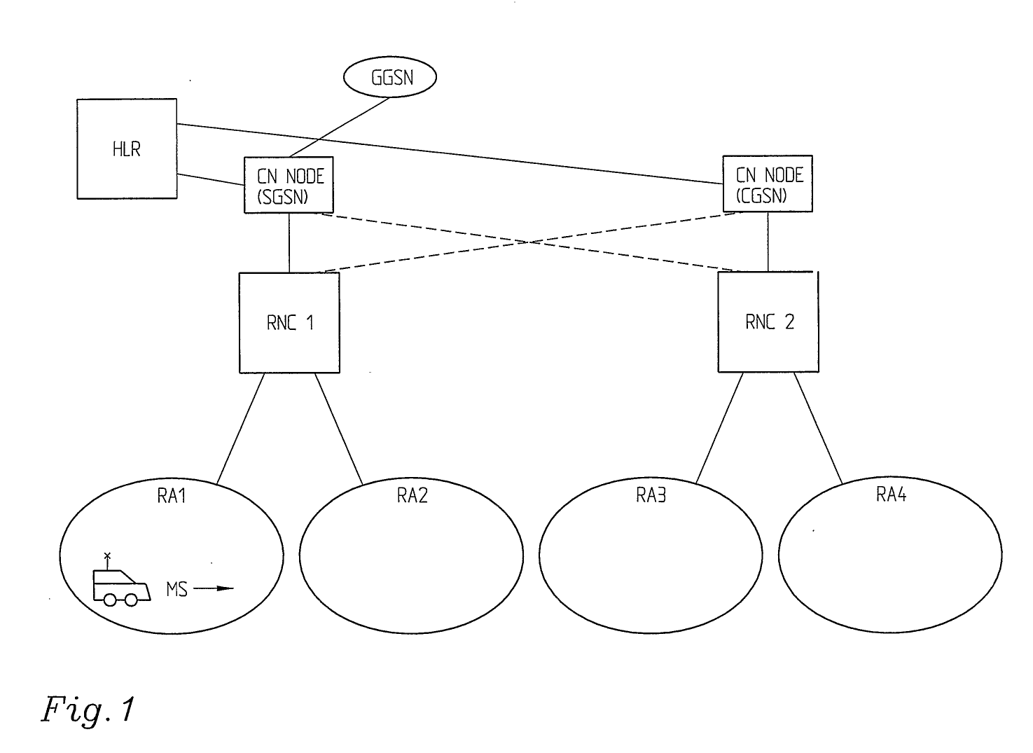

FIG. 1 very schematically illustrates a mobile telecommunication system with a Mobile Station MS. It comprises a core network with Core Network nodes, CN nodes, in the figure it is illustrated one SGSN (Serving GPRS Support Node) and one CGSN which comprises the combined functionality of an SGSN and a gateway GPRS, as CN nodes in the packet switched domain of the network. The core network is connected to a radio access network, in the case of a UMTS system the radio access network comprises a UTRAN as referred to earlier in the application. UTRAN comprises a number of base stations (not shown). Each base station is controlled by a Radio Network Controller RNC, each RNC controlling a number of base stations and hence controlling the respective routing areas in which the mobile station may move, in the illustrated figures RNC 1 controls routing areas RA1 and RA2, whereas RNC 2 controls RA3 and RA4.

The core network nodes are connected to a Home Location Register HLR. The dashed connection lines between CGSN and RNC1 and SGSN and RNC2 illustrate that the core network nodes may be comprised in a pool of core network nodes. This is however not necessary for the functioning on the inventive concept but merely shows a particular implementation. In the general implementation the CN nodes are not arranged in pools. However, this is of no importance for the functioning of the present invention.

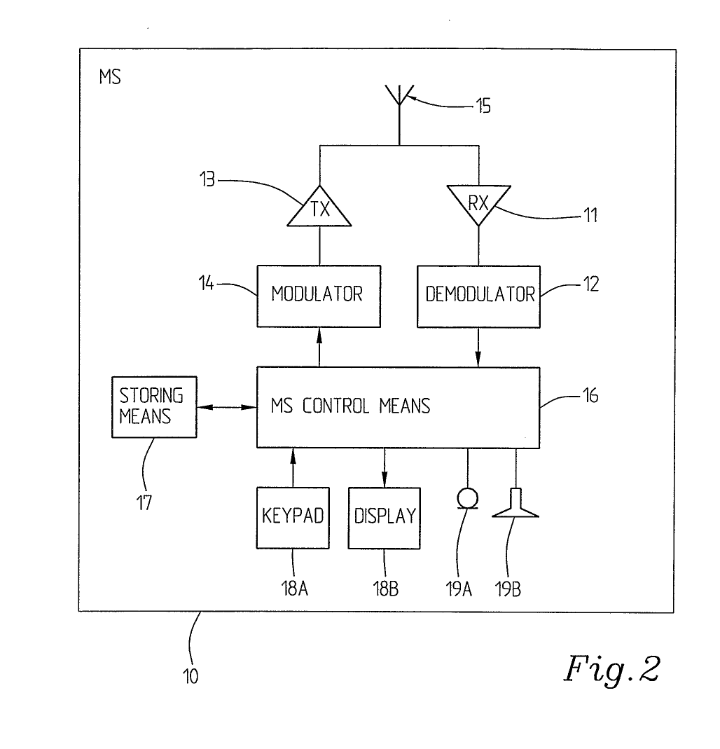

FIG. 2 schematically illustrates some constituent components of a mobile station MS 10. The MS 10 is adapted for wireless communication, here according to the UMTS standard. It comprises a modulator 14 connected to a transmitter TX 13 for transmitting signals via antenna 15 to a base station (not shown). The antenna 15 furthermore is connected to a receiver RX 11, which in turn is connected to a demodulator 12 for handling received signals. The interface communicating with the communication network may comprise several other components, which however are not shown in this figure since they are not relevant for the functioning of the present invention. The signals includes signalling information in accordance with the air interface standard of the applicable system in which the mobile station 10 operates. The modulator 14 and the demodulator 12 are connected to mobile station control means 16. The MS control means 16 comprises circuitry required for implementing the audio and logic functions of the mobile station 10. It may comprise a digital signal processor, a microprocessor, various analogue and digital converters, ASICs (Application Specific Integrated Circuits) and other components. The control and signal processing functions of the mobile station 10 are allocated between these components and devices in the appropriate manner. The MS control means 16 further comprises receiving means and transmitting means such as input and output terminals on which messages according to the invention may be received transmitted for the receiver 13 and the transmitter 13 respectively. The MS control means 16, according one embodiment, is responsible for sending, receiving and interpreting request messages and response messages and to take the appropriate actions in dependence thereof, according to the present invention and this will be further described below.

The mobile station 10 further comprises storing means 17 which may comprise a Random Access Memory, RAM, a Read Only Memory, ROM, and SIM/USIM (Subscriber Identity Module/UMTS SIM) card etc. For reasons of simplicity, however, the different storing means are illustrated as one storing means 17. The storing means 17 of the mobile station may store permanent and temporary values of various system parameters and mobile terminal specific information such as P-TMSI. The storing means may also comprise different protocols for initiating and controlling communication using the communication interface. In one embodiment computer readable instructions are stored in the storing means, which may carry out the method according to the present invention when run by the MS control means 16 having digital computer capabilities. The MS control means 16 may also comprise a register for storing data and/or instructions for carrying out the method according to the inventive concept. In a conventional manner the communication interface also comprises a keypad 18A, a display 18B, a microphone 19A, and a loudspeaker 19B, or a connection for a handsfree set.

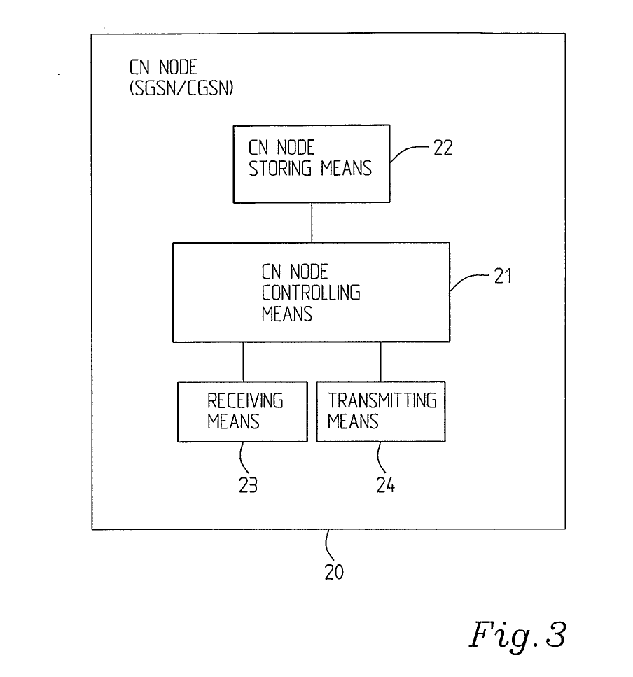

FIG. 3 is a schematical block diagram of a core network node CN node 20 by means of which the inventive concept can be implemented. The CN node 20 particularly comprises an SGSN, alternatively a CGSN. It may also be any other node with a similar functionality or any other appropriate node.

The CN node 20 comprises CN node controlling means 21 responsible for controlling and executing network communication and protocol based procedures, e.g. according to the GMM protocol. The CN node controlling means 21 comprises the circuitry required for implementing the logical functions of the node. It may comprise one or a plurality of one or more of digital signal processors, microprocessors, analogue and digital converters, ASICs as well as other components for communication with a mobile station 10 over one or more access nodes, e.g. base stations etc. The CN node controlling means 21 is connected to receiving means 23, and transmitting means 24 for receiving/transmitting for example data from/to the mobile station 10. The CN node controlling means 21 further comprises receiving input means and transmitting output means on which messages may be received from the receiving means 23 and transmitted to the transmitting means 24 respectively. The CN node further comprises CN node storing means 22 e.g. comprising a RAM and a ROM etc. In the CN node storing means 22 a plurality of constants and variables used by the controlling means 21 during operation of the network node are stored. The storing means 22 may further store permanent and temporary values of various system parameters and mobile station specific information such as P-TMSI relating to one or more mobile stations. In a particular embodiment the CN node storing means 22 also comprises protocols for initiating and controlling communication. Computer readable instructions may be stored in the storing means which may carry out the method according to the invention when run by the CN node control means 21. The CN node control means 21 may also comprise a register for storing data and/or instructions for carrying out the method according to the present invention. It should be clear that the node of course also comprises a plurality of other components which, however, not are of importance for the functioning of the present invention.

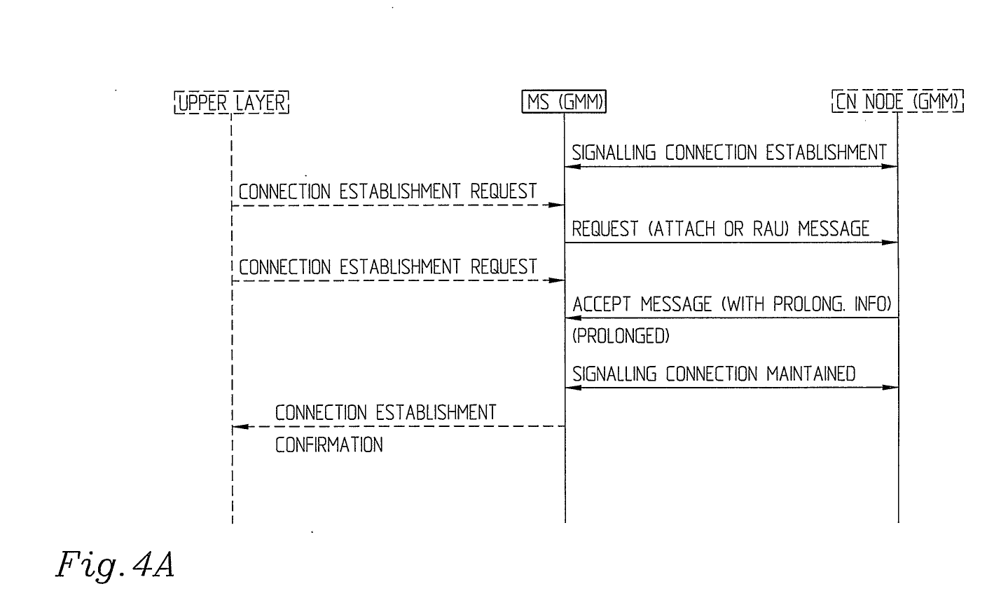

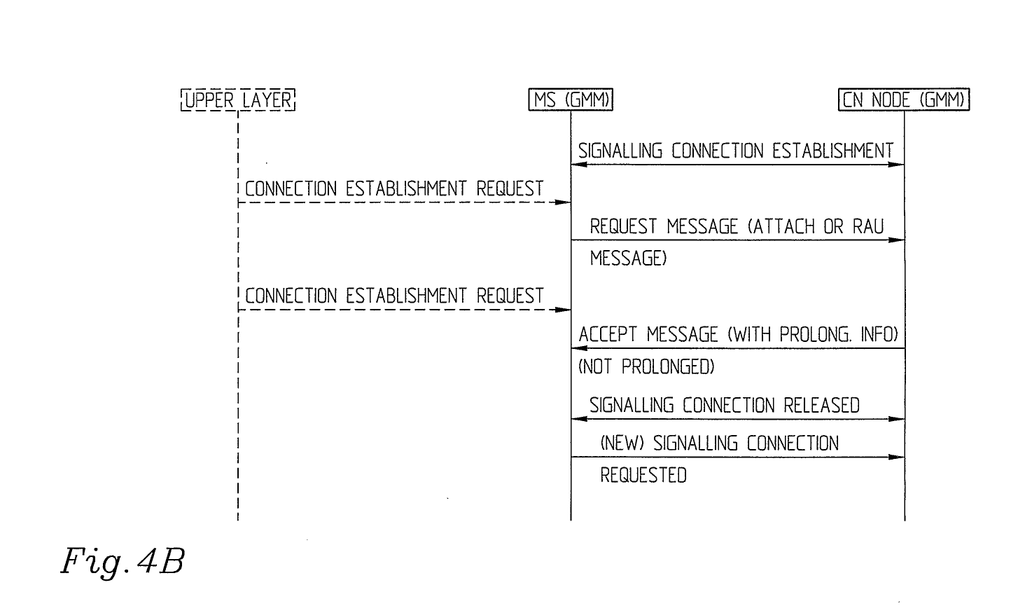

FIGS. 4A,4B show two signalling diagrams illustrating each a signalling scheme illustrating the inventive procedure, in FIG. 4A the procedures are illustrated when a signalling connection establishment is prolonged whereas in FIG. 4B an established PS signalling connection is not prolonged.

The GMM protocol supports packet switched services and it is a mobility management protocol for supporting procedures such as location management, authentication, temporary identity management and equipment checks. The GMM protocol serves upper layers and initiate, establish and manage signalling connections for the layers above them, i.e. the upper layers, in the protocol stack. The GMM protocol obtains signalling connections, over which the upper layers may transmit information. Requests for obtaining the connections are triggered by a so called GMM unit (the functioning for CS communication is performed by the MM protocols). A request to establish or initiate a connection may be provided by a RRC (Radio Resource Control) message which for example carries a layer 3 (L3) message, e.g. an attach request, routing area update request or a service request in general initiated by the GMM unit of the MS. These requests may each trigger an establishment of a PS connection to the network core node. After the signalling connection has been established, the GMM unit of a mobile station may transmit a request for a specific GMM procedure over said connection to the CN node. The request may for example be incorporated into a RRC message.

When the mobile station for example moves from one routing area to another routing area, routing area updating has to be performed. (Also in other cases it is performed, periodically etc.) Procedures for downloading for examples parameters for the new routing area have to be provided when the mobile station enters the new routing area. Such requests for mobility management are also handled by the GMM.

According to the present invention the GMM unit of the core network node generates a response to the request, i.e. to the attach request or the routing area update request, and returns said response as an acceptance message, also denoted an accept. This accept generally indicates that the request has been received and that it is handled. According to the present invention information is included in the accept message, which e.g. either comprises an attach accept or a routing area update accept message. The information included in the acceptance message comprises information as to whether the established signalling communication is prolonged or not. According to the invention information about prolongation or not prolongation of the established signalling connection is provided irrespectively of whether a request for prolongation or not has been provided by the mobile station. The information may comprise a so called Follow-On Proceed (FOP) indicator. The FOP comprises in one advantageous embodiment one bit indicating either “0” meaning No Follow-On Proceed, i.e. that the signalling connection is not prolonged. Alternatively it may comprise “1”, Follow-On Proceed, i.e. the signalling connection is prolonged. It is not needed to modify or add any information element (IE) in the messages, i.e. the attach accept or routing area update accept messages as defined in 3GPP TS 24.008, since the attach accept message contains a spare bit in the “attach result” IE which can be used for FOP, and, correspondingly the routing area accept message contains a spare bit in the “update result” information element which can be used for the FOP.

Alternatively information might only be provided if the established signalling connection is prolonged, or only if it is not prolonged respectively. Different alternatives are possible.

In FIG. 4A it is supposed that FOP is set to valid, i.e. that the signalling connection is maintained. The signalling connection establishment is then maintained and the mobile station will confirm a connection establishment to the upper layer having requested a connection establishment.

If it is determined by network to prolong an established PS signalling connection, the network, i.e. the core network node, particularly SGSN or CGSN, provides a message to that effect in the acceptance message, particularly in the attach accept or routing area update accept message. Particularly this is done by setting a Follow-On Proceed (FOP) indicator on. One reason for prolonging an established connection may be that the mobile station has indicated a Follow-On Request pending in an attach request or a routing area update message, i.e. that the mobile station has requested that the connection be prolonged. However there may also be other reasons for the network, or the core network node, to prolong a signalling connection.

After receiving the acceptance message with an indication as to whether the signalling connection is prolonged or not, the mobile station is well capable of taking the most relevant actions.

FIG. 4B shows a signalling diagram similar to that of FIG. 4A but with the difference that the accept message indicates that the signalling connection is not prolonged. The signalling connection is then released and the mobile station has to request establishment of a new signalling connection.

Thus, through the provision of the information in the acceptance message, a mobile station gets a possibility to act accurately since it will be aware of the fact that a signalling connection is maintained or not which is clearly advantageous. If for example information is provided in the acceptance message, and the mobile station has a connection management (CM) application request pending, the mobile station shall send an appropriate message to the network, i.e. to the CN core node. This may for example be an activate PDP context request. It may of course also be some other message.

If a GMM specific procedure is running at the time when the request from the CM sub layer is received, and an attach request message or a routing area update request message has already been sent, the request will either be rejected or delayed, i.e. the request from the CM sub layer, depending on implementation, until the GMM specific procedure has been finished. If the message contains information that the signalling connection is not prolonged in the acceptance message, the PS signalling connection is released.

If the attach request or routing area update request message has not yet been sent, the mobile station may set a Follow-On Request pending indicator on in the attach request or routing area update request message, i.e. it may request prolongation. The mobile station shall then delay the request from the CM sub layer until the GMM specific procedure is completed, then the network may allow the mobile station to use a prolonged PS signalling connection.

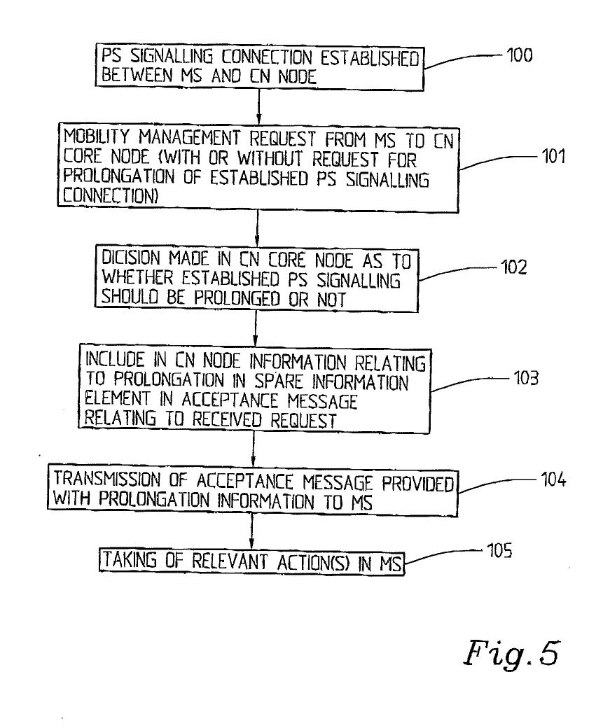

FIG. 5 is a schematical flow diagram illustrating one embodiment of the inventive concept. It is first supposed that a PS signalling connection is established between a mobile station MS and a CN node, 100. A mobility management request is then sent from the MS to the CN node, with or without a request for prolongation of the PS signalling connection, 101. In the CN node a decision is made as to whether the established PS signalling connection should be prolonged or not, 102. If, as referred to above, the request from the mobile station included a request for prolongation, this may be taken into account by the CN node, although it of course does not have to prolong the connection just because of that. It may also prolong the connection without there being a request from the node, or it may not prolong the connection. In the CN node the information relating to prolongation or not prolongation is included in a spare information element part in an acceptance message that is related to the request received from a mobile station, 103. Subsequently the CN node transmits the acceptance message provided with prolongation information to the MS, 104. The MS is then capable of taking the accurate, relevant actions depending on the information as to whether the established signalling connection was prolonged or not, 105.

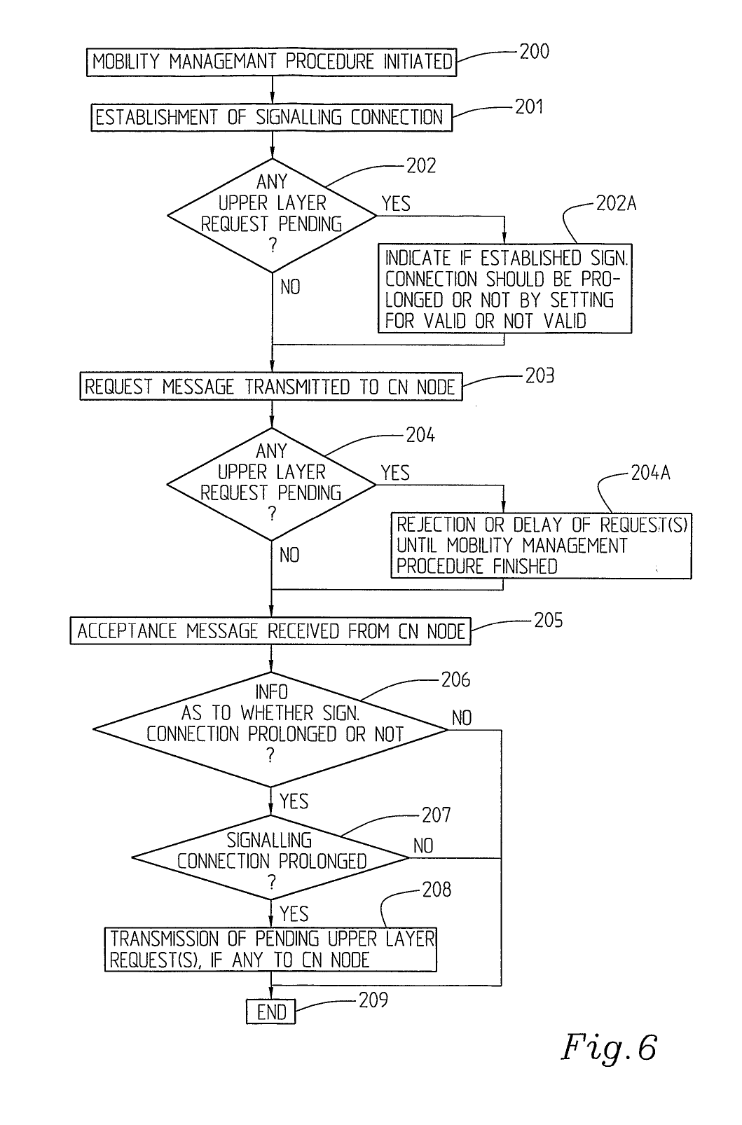

FIG. 6 is a flow diagram describing the procedural steps carried out in the mobile station according to one embodiment of the present invention. It is first supposed that a mobility management procedure is initiated, 200. A signalling connection is then established with the CN node in a conventional manner, 201. It is then established whether there is any upper layer request pending, 202. Then it is determined whether a prolongation should be requested, e.g. by setting FOR to valid or not valid, 202A. A request message (with or without FOR, valid or not) is then transmitted to the CN node, 203. Again it is established if there is any upper layer request pending, 204. If yes, the request or requests is/are rejected or delayed, depending on the specific application etc., until the mobility management procedure has been finished, 204A. Then, and also if there was no pending upper layer request, an acceptance message is received from the CN node, 205. It is subsequently established if the acceptance message contains information as to whether the established signalling connection is prolonged or not, 206. If yes, it is established if the signalling connection actually is prolonged, 207. If yes, the transmission of pending upper layer request(s), if any, to the CN node is performed, 208. If, on the other hand there was no information as to prolongation of the signalling connection or the signalling connection was not prolonged, the mobile station has to request a new signalling connection etc. The procedure is then ended, 209.

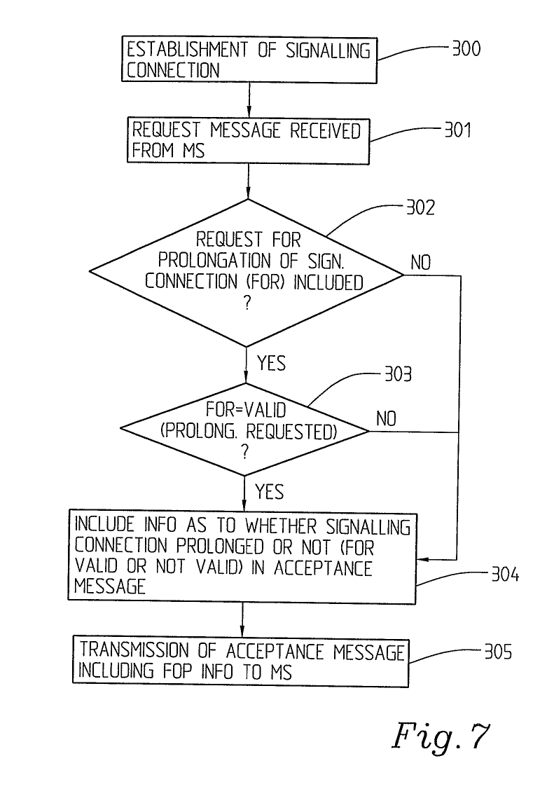

FIG. 7 schematically illustrates the steps at the CN node according to one embodiment of the present invention. Thus, it is supposed that first a signalling connection is established, 300. It is then supposed that a request message is received from the MS, 301. The request message particularly either comprises an attach request message or a routing area update request message. It is then established if there is any request for prolongation of the established signalling connection included, 302. If yes, it is established if the FOR, i.e. the request for prolongation, is valid, i.e. if prolongation is requested, 303. If yes, information is included as to whether the signalling connection is prolonged or not, e.g. if FOP is valid or not, in the acceptance message to be returned to the mobile station, 304. It should be clear that this message is included also if the request for prolongation was included or if an information element part was included but it did not request prolongation, i.e. not valid. Subsequently the acceptance message including FOP information is transmitted to the mobile station, 305. It should be clear that the acceptance may contain a negative or a positive response to the request for prolongation, if there has been one, just as well as if there has been no request therefore, the main thing being that the mobile station will be aware about the situation, i.e. if the signalling connection is prolonged or not. Moreover, according to different implementations, or if possible, the CN node may always try to prolong the signalling connection upon request.

It should be clear that the invention can be varied in a number of ways and it is not limited to the specifically illustrated embodiments. It is an advantage of the invention that the error cases referred to initially due to the solutions specified in TS 24.008 can be removed. It is also an advantage of the invention that not needed signalling between the mobile station and the network is reduced, waste of radio resources is reduced, and the battery life of mobile station can be prolonged.

Still further, the mobile station gets knowledge of what the network has decided to do whether an established PS signalling connection is prolonged or not and gets the possibility to take the appropriate action having regard to that.

It is also an advantage that the procedure according to the invention does not change the behavior of the network with regard to the existing FOR indicator. No new information elements have to be added in existing messages and preferably an existing spare bit can be used in the respective messages to carry the follow-on proceed indicator, or the information as to whether prolongation is done or not.

1-36. (canceled)

37. An arrangement in a core network node in a mobile radio communication system for prolonging a packet-switched signalling connection between the core network node and a mobile station, said arrangement comprising:
means for receiving a request message from the mobile station;
means for deciding whether to prolong the packet-switched signalling connection; and
means for providing information to the mobile station as to whether or not the packet-switched signalling connection is being prolonged.

38. The arrangement according to claim 37, wherein the means for providing information to the mobile station includes means for sending a response message to the mobile station in response to the request message, said response message including an indication as to whether or not the packet-switched signalling connection is being prolonged.

39. The arrangement according to claim 38, wherein the request message received from the mobile station is a mobility management request message.

40. The arrangement according to claim 39, wherein the response message is an acceptance message concerning the mobility management request message received from the mobile station.

41. The arrangement according to claim 39, wherein the request message received from the mobile station includes a request for prolongation of the packet-switched signalling connection.

42. The arrangement according to claim 41, wherein the mobile communication system is a Universal Mobile Telecommunication System (UMTS), and the core network node is a Serving GPRS Support Node (SGSN).

43. The arrangement according to claim 42, wherein the prolongation request comprises a Follow-on Request (FOR).

44. The arrangement according to claim 38, wherein the indication in the response message as to whether or not the packet-switched signalling connection is being prolonged is placed in an existing, non-used part of an information element (IE) of the response message.

45. The arrangement according to claim 44, wherein the indication in the response message as to whether or not the packet-switched signalling connection is being prolonged comprises a single bit.

46. A mobile station supporting communication of packet data in a mobile radio communication system, said mobile station comprising:
means for sending a request message over an established packet-switched signalling connection to a packet data node;
means for receiving a response message from the packet data node and extracting from the response message, an indication of whether or not the packet-switched signalling connection is being prolonged;
means for interpreting the extracted indication, and
control means for determining whether to send an additional request message to the packet data node based on an interpretation of the extracted indication.

47. The mobile station according to claim 46, wherein the means for sending a request message includes means for sending a mobility management request message to the packet data node.

48. The mobile station according to claim 47, wherein the means for sending a mobility management request message also sends a request to prolong the packet-switched signalling connection.

49. The mobile station according to claim 48, wherein the control means includes means for preventing the mobile station from sending additional requests to prolong the packet-switched signalling connection if the extracted indication indicates that the packet-switched signalling connection has been terminated.

50. The mobile station according to claim 48, wherein the control means includes means for preventing the mobile station from sending a request to establish a new packet-switched signalling connection if the extracted indication indicates that the packet-switched signalling connection has been prolonged.

51. The mobile station according to claim 48, wherein the control means includes:
means for delaying or rejecting upper layer requests to the packet data node if a GPRS Mobility Management (GMM) procedure is running; and
means for sending to the packet data node, a request to prolong the packet-switched signalling connection when the GMM procedure is terminated.

52. A method in a mobile radio communication system for prolonging a packet-switched signalling connection between a core network packet data node and a mobile station, said method comprising:
establishing a packet-switched signalling connection between the packet data node and the mobile station;
sending a request message from the mobile station to the packet data node over the packet-switched signalling connection;
deciding in the packet data node whether to prolong the packet-switched signalling connection;
sending a response message from the packet data node to the mobile station, said response message including an indication as to whether or not the packet-switched signalling connection is being prolonged; and
controlling actions in the mobile station based on whether or not the packet-switched signalling connection is being prolonged.

53. The method according to claim 52, wherein the step of sending a request message includes:
sending a mobility management request from the mobile station to the packet data node; and
sending with the mobility management request, a request for prolongation of the packet-switched signalling connection.

54. The method according to claim 52, wherein the step of sending a response message from the packet data node to the mobile station includes adding at least one information bit to an existing, defined acceptance message relating to the received request message, said at least one information bit indicating whether or not the packet-switched signalling connection is being prolonged.

55. The method according to claim 52, wherein the step of controlling actions in the mobile station includes:
delaying or rejecting upper layer requests to the packet data node if a mobility management procedure is running; and
sending to the packet data node, a request to prolong the packet-switched signalling connection when the mobility management procedure is terminated.

56. The method according to claim 52, wherein the step of controlling actions in the mobile station includes preventing the mobile station from sending additional requests to prolong the packet-switched signalling connection if the extracted indication indicates that the packet-switched signalling connection has been terminated.

57. The method according to claim 52, wherein the step of controlling actions in the mobile station includes preventing the mobile station from sending a request to establish a new packet-switched signalling connection if the extracted indication indicates that the packet-switched signalling connection has been prolonged.
